(19) United States
(12) Patent Application Publication
(10) Pub. No.: US 2006/0279499 A1
(43) Pub. Date: Dec. 14, 2006

(54) Organic light-emitting device

(75) Inventors: Seung-Kyu Park, Seoul (KR); Jong-Moo Huh, Hwaseong-si (KR); Nam-Deog Kim, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/450,197

(22) Filed: Jun. 9, 2006

(30) Foreign Application Priority Data
Jun. 10, 2005 (KR) 2005-49906

(51) Int. Cl. G09G 3/36

(52) U.S. Cl. 345/92

(57) ABSTRACT

An organic light-emitting device (OLED) includes an array of scan lines, data lines and power supply lines having a connecting section inserted in each data. The connecting section controllably connects m number of the power supply lines that are adjacent to each other so that should and an electrical short occur where the power supply lines and the fan-out region of the data lines cross lines in different layers, or in adjacent lines that are formed from the same layer, the effect of the short can be minimized.

### CROSS-REFERENCE TO RELATED APPLICATIONS

This application relies for priority upon Korean Patent Application No. 2005-49906 filed on Jun. 10, 2005, the contents of which are herein incorporated by reference in its entirety.

### FIELD OF THE INVENTION

The present invention relates to an organic light-emitting device. More particularly, the present invention relates to an organic light-emitting device having a repair structure.

### BACKGROUND OF THE INVENTION

Cathode ray tube (CRT) devices are widely used as display devices. However, the proportion of liquid crystal display (LCD) devices being used as display devices for computers is increasing. On the one hand, a CRT device is heavy and large, while an LCD device has low luminance, a narrow-viewing angle and low efficiency. As a result, both the CRT and the LCD devices are not able to completely achieve user satisfaction. A substantial amount of research is being conducted to develop next-generation display devices, which have high efficiency, and are low in price, thin, lightweight, etc. One noteworthy next-generation display device is an organic light-emitting device (OLED) which generates light using electro-luminescence of an organic material or polymers without need for a backlight source. Accordingly, the OLED can be thinner and have a lower manufacturing cost than that of the LCD device. In addition, the OLED has a wider viewing angle and a higher luminance than that of and LCD.

FIG. 1 is a schematic equivalent circuit diagram illustrating a unit pixel section of a conventional OLED which includes a switching transistor QS, a storage capacitor CST, a driving transistor QD and an organic electro-luminescent element EL. A power supply line VDL may be formed through a process of manufacturing a data line DL in a direction that is substantially parallel with the data line DL. A pixel is electrically connected to each of the power supply lines VDL. The number of the pixels that are electrically connected to each power supply line VDL is equal to that of scan lines. To drive the organic electro-luminescent element EL three kinds of signals, such as a scan signal, a data signal and a bias power voltage, are required. The input signal is applied from an external device to the scan line SL controls switching transistor QS which, in turn, controls driving transistor QD. The data line DL is substantially parallel with the power supply line VDL. Each of the lines is electrically insulated from each other. However, when the lines are electrically shorted to each other, an abnormal signal (or voltage) is transferred to the organic electro-luminescent element EL. On the contrary, when one of the lines is open, an ordinary signal (or voltage) is prevented from reach the organic electro-luminescent element EL. The gap between the data lines and the power supply lines, which is kept small to improve the pixel aperture ratio, may not be sufficient to avoid shorting the two lines whose repair is not easily performed.

### SUMMARY OF THE INVENTION

In accordance with the present invention an arrangement is provided according to which a line-unit-error that may occur in some portion of the array of organic light emitting devices is isolated to a pixel-unit-error, so that damage due to a short circuit defect is minimized. A connection unit is inserted in each of the data lines leading to the columns of the display and the power supply lines for the columns are under the control of a power supplying section. A crossing area between the power supply line and the fan-out region of the data line, or between the power supply line and the fan-out region of the scan line is formed to be minimized, so that an electrical short probability is decreased in the lines that are formed from different layers, or in adjacent lines to each other that are formed from the same layer. Furthermore, a power supply line includes an independent repair structure, so that a repairing process may be easily performed.

### BRIEF DESCRIPTION OF THE DRAWINGS

The above and other advantages of the present invention will become readily apparent by reference to the following detailed description when considered in conjunction with the accompanying drawings wherein:

FIG. 1 is a schematic equivalent circuit diagram illustrating a unit pixel section of a conventional organic light-emitting device (OLED);

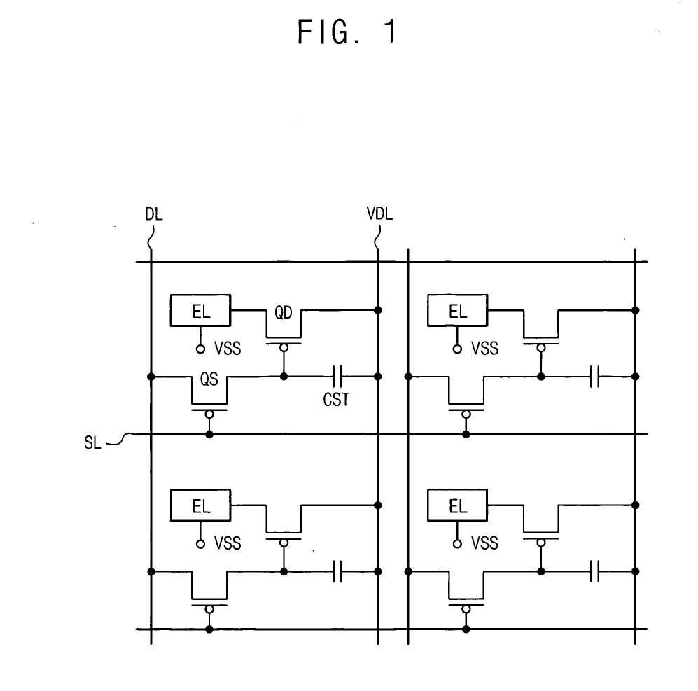

FIG. 2 is a block diagram illustrating an OLED according to an example embodiment of the present invention;

FIG. 3 is a plan view illustrating a portion of an OLED display panel according to an example embodiment of the present invention;

FIG. 4 is a plan view illustrating a portion of an OLED display panel according to another example embodiment of the present invention;

FIG. 5 is a block diagram illustrating an OLED according to still another example embodiment of the present invention;

FIG. 6 is a plan view illustrating a portion of an OLED display panel according to still another example embodiment of the present invention;

FIG. 7 is a plan view illustrating a portion of an OLED display panel according to further still another example embodiment of the present invention;

FIG. 8 is a plan view illustrating a portion of an OLED display panel according to further still another example embodiment of the present invention;

FIG. 9 is a block diagram illustrating an OLED according to further still another example embodiment of the present invention;

FIG. 10 is a plan view illustrating a unit pixel section and a connecting section in FIG. 9;

FIG. 11 is a block diagram illustrating an OLED according to further still another example embodiment of the present invention; and

FIG. 12 is a plan view illustrating a unit pixel section and a connecting section in FIG. 11.

### DESCRIPTION

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items. Spatially relative terms, such as “beneath,” “below,” “lower,” “above,” “upper” and the like, may be used herein for ease of description to describe one element or feature's relationship to another element(s) or feature(s) as illustrated in the figures. Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

### Embodiment 1

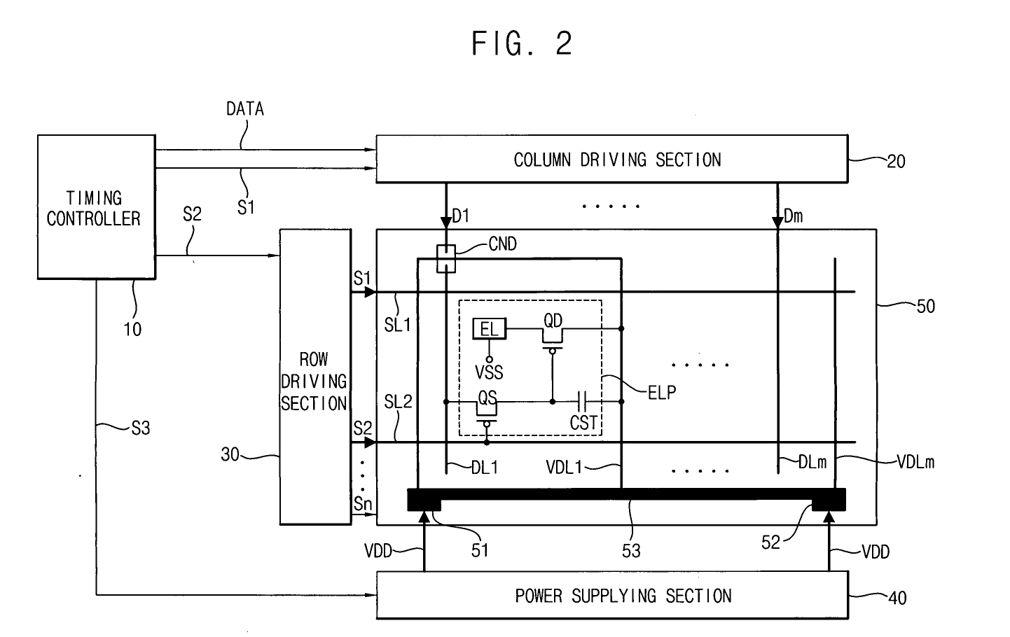

FIG. 2 is a block diagram illustrating an OLED according to an example embodiment of the present invention. In FIG. 2, the two portions of each data line D1-Dm are electrically connected to each other through a contact hole and a bridge pattern CND. Referring to FIG. 2, the OLED includes a timing controller 10, a column driving section 20, a row driving section 30, a power supply section 40 and an OLED display panel 50. The timing controller 10, the a column driving section 20, the row driving section 30 and the power supply section 40 corresponds to a driving apparatus of the OLED display panel 50. Timing controller 10 receives an image signal and control signal provided from an external graphic controller (not shown) and generates first and second timing signals S1 and S2 and a power control signal S3. Timing controller 10 provides the column driving section 20 with the image signal DATA and the first timing signal S1. Timing controller 10 provides the row driving section 30 with the second timing signal S2 and also provides the power supplying section 40 with the power control signal S3.

In response to the image signal DATA and the first timing signal S1, column driving section 20 and outputs data signals D1, D2, . . . , Dm−1 to the OLED display panel 50. In response to the second timing signal S2, row driving section 30 sequentially outputs scan signals S1, S2, . . . , Sn−1, Sn to OLED display panel 50. In response to the power control signal S3, power supply section 40 provides a bias power voltage VDD to a plurality of power supply lines leading into the OLED display panel 50.

OLED display panel 50 includes a first station 51, a second station 52 and a bridge line 53 that connects to the first station 51 and the second station 52. The first and second stations 51 and 52 and the bridge line 53 are formed on a first inactive display region of the OLED display panel 50. The OLED display panel 50 includes a plurality of OLED pixel sections ELP. The OLED pixel sections ELP are formed on an effective display region defined by m number of data lines D1-Dm, m number of power supply lines VDL-VDLm and n number of scan lines SL1-SLn. The power supply lines VDL transfer a bias power voltage VDD to the effective display region. The OLED display panel 50 emits light by controlling a current corresponding to the bias power voltage VDD and the data signals D1, D2, . . . , Dm−1 and Dm in response to the scan signals S1, S2, . . . Sn−1 and Sn. The OLED pixel section ELP includes a switching transistor QS, a driving transistor QD, an electro-luminescent element EL and a storage capacitor CST. The OLED pixel section ELP displays images in accordance with an image signal outputted from the column driving section 20 in response to a scan signal outputted from the row driving section 30.

In FIG. 2, the switching transistor QS is gated on by a data signal appearing on one of lines D1-Dm at the same time that a scanning signal is applied to one of scan lines S1-Sn. When gated on, switching transistor QS activates driving transistor QD which energizes the electro-luminescent element EL. As shown, switching transistor QS corresponds to, for example, a P-type metal-oxide semiconductor (PMOS) transistor. Alternatively, the switching transistor QS may correspond to an N-type metal-oxide semiconductor (NMOS) transistor. A channel layer of the PMOS transistor includes polysilicon (poly-Si), and a channel layer of the NMOS transistor includes amorphous-silicon (a-Si). Electro-luminescent element EL may include a pixel electrode, an opposite electrode facing to the pixel electrode and an electro-luminescent layer between the pixel electrode and the opposite electrode. The electroluminescent layer includes a hole injecting layer, a hole transporting layer, a light-emitting layer and an electron transporting layer that are sequentially formed on the pixel electrode layer. Alternatively, the electro-luminescent element EL may include a hole transporting layer, a light-emitting layer and an electron transporting layer that are sequentially formed on the pixel electrode. Moreover, the electro-luminescent element EL may include a hole injecting layer, a hole transporting layer, a light-emitting layer, an electron transporting layer and a hole injecting layer sequentially formed on the pixel electrode.

In FIG. 2, the driving transistor QD corresponds to, for example, a PMOS transistor. Alternatively, the driving transistor QD may correspond to a NMOS transistor. A channel layer of the PMOS transistor may includes polysilicon (poly-Si), and a channel layer of the NMOS transistor may includes amorphous-silicon (a-Si). Storage capacitor CST includes a first terminal and a second terminal, and stores a driving voltage. The first terminal is electrically connected to a third terminal of the switching transistor QS. The second terminal is electrically connected to the power supply line VDL.

Power supply lines VDL1-VDLm are formed substantially parallel with the data lines DL1-DLm. Two or more adjacent power supply lines VDL are electrically connected to each other. The power supply lines VDL transfer a bias power voltage VDD that is applied from bridge line 53 to the OLED pixel section ELP.

Each of the data lines D1-Dm leading to a respective OLED pixel section ELP includes a connecting section CND that is formed on a crossing area with a respective one of power supply lines VDL1-VDLm. The connecting section CND electrically connects to a first portion of an open data line DL and a second portion of the open data line DL, which is separated from the first portion. The connecting section CND is formed in an inactive display region of the OLED display panel 50. The open 7′ data line DL is one of even-numbered data lines DL. In other words, even-numbered data lines DL are opened, and portions of each of the open data lines DL are electrically connected through the connecting section CND.

Bias power voltage VDD from power supplying section 40 is applied to the first and second stations 51 and 52 and, in turn, to the power supply lines VDL that are formed on the effective display region of the OLED display panel 50. In FIG. 2, OLED display panel 50 includes, for example, two stations. Alternatively, the OLED display panel 50 may include three or more stations in order to uniformly apply the bias power voltage that is applied from an external device to the OLED display panel 50.

As shown in FIG. 2, the power supply line VDL and the data line DL may be formed from the same layer, and substantially parallel to the data line DL. The data line DL is electrically connected to a driving integrated circuit (IC) in an upper portion of the OLED display panel 50. The power supply line VDL is electrically connected to a bridge line 53 in a lower portion of the OLED display panel 50. An even-numbered power supply line and an odd-numbered-power supply line are electrically connected to each other in order to prevent a short defect. A portion of the data line DL, which corresponds to overlapping area between the power supply line VDL and a data line DL, is removed to divide the data line DL into two portions. However a first portion and a second portion of the data line are electrically connected to each other through the connecting section CND, so that a data signal D1 is normally applied to the unit pixel section ELP.

According to the above-mentioned structure, two or more adjacent power supply lines VDL are electrically connected to each other. Therefore, even though short defects occur in some of the power supply lines VDL, a bias power voltage may be applied to a unit pixel section ELP through another power supply line adjacent to the open power supply line VDL, so that damage due to the short defects is minimized. In other words, a line-unit-error that occurs in some of the power supply lines VDL is converted to a pixel-unit-error, so that damage due to the short defects corresponding to the line-opening is minimized.

Also, two or more adjacent power supply lines are electrically connected to each other in an inactive display region. Therefore, even though an electrical short may occur between the power supply line and the data line, two portions of the power supply line having the electrical short may be opened. Therefore, a repairing process may be easily performed. Furthermore, a crossing area between the power supply line and the data line may be decreased in a fan-out region. For example, the crossing area may be reduced from an order of ‘mm²’ to an order of ‘μm²’. Therefore, damage due to an electrical short that may occur, between a fan-out layer of the power supply line that is formed from the same layer as the gate electrode layer, and a power supply line that is formed from the same layer as the source-drain electrode layer, is minimized.

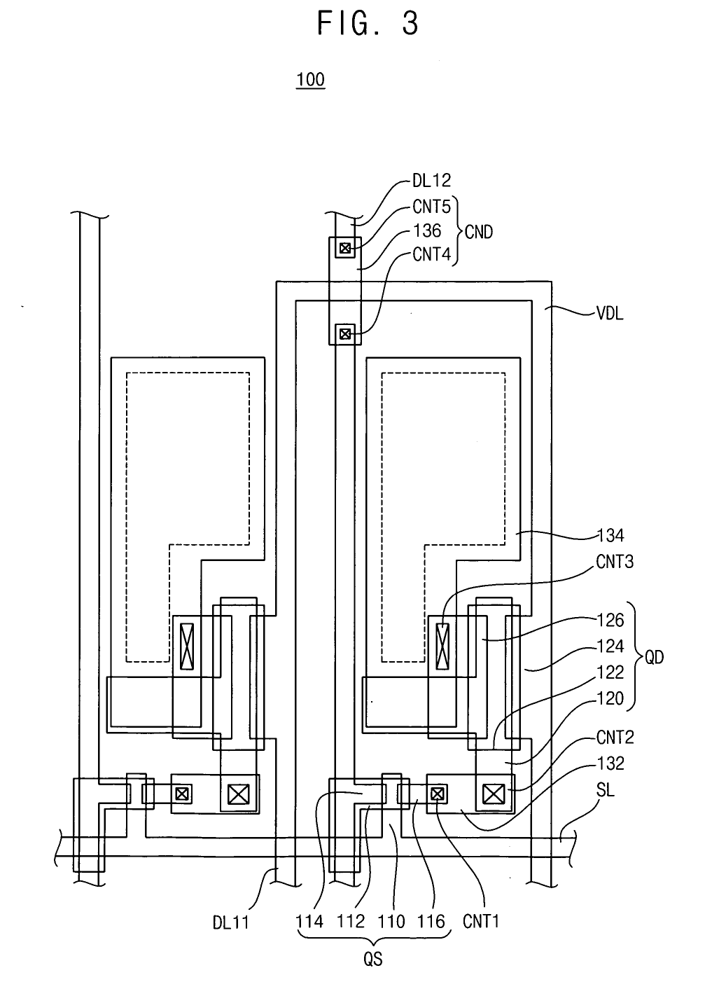

FIG. 3 is a plan view illustrating a portion of an OLED display panel according to an example embodiment of the present invention. Particularly, FIG. 3 is a layout illustrating a unit pixel section and a connecting section of the OLED display panel of FIG. 2. Referring to FIGS. 2 and 3, a unit pixel section ELP that is disposed in an OLED display panel 100 according to an example embodiment of the present invention is formed in a portion defined by a scan line SL supplying a scan signal, a data line DL supplying a data signal and a power supply line VDL supplying a bias power voltage VDD.

The scan line SL, the data line DL and the power supply line VDL may have a single layer structure or a double layer structure. For example, when the scan line SL has the single layer structure, the scan line SL includes aluminum (Al) or aluminum-neodymium (Al—Nd) alloy. Alternatively, when the scan line SL has the double layer structure, a lower layer of the scan line SL includes metal having a relatively good mechanical and chemical characteristics, such as chromium (Cr), molybdenum (Mo), molybdenum alloy, etc., and an upper layer of the scan line SL includes metal having relatively low specific resistance, such as aluminum (Al), aluminum alloy, etc. Although the above embodiment discloses a single layer structure and a double layer structure, a multi-layer structure such as a triple layer structure, a quadruple layer structure or any other configuration known to one of ordinary skill in the art may also be employed in place of or in conjunction with the single layer structure.

The unit pixel section ELP includes a switching transistor QS and a driving transistor QD. The switching transistor QS includes a first gate electrode 110, a first active layer 112, a first source electrode 114 and a first drain electrode 116. The first gate electrode 110 is extended from the scan line SL. The first active layer 112 covers the first gate electrode 110. The first source electrode 114 is extended from the data line DL, so that the first source electrode 114 covers a first portion of the first active layer 112. The first drain electrode 116 is spaced apart from the first source electrode 114, so that the first drain electrode 116 covers a second portion of the first active layer 112.

The driving transistor QD includes a second gate electrode 120, a second active layer 122, a second source electrode 124 and a second drain electrode 126. The second gate electrode 120 is patterned, and spaced apart from the scan line SL. The second active layer 122 covers the second gate electrode 120. The second source electrode 124 is extended from the power supply line VDL that is formed substantially parallel with the data line DL, so that the second source electrode 124 covers a portion of the second active layer 122. The second drain electrode 126 is spaced apart from the second source electrode 124, so that the second drain electrode 126 covers another portion of the second source electrode 124. The first drain electrode 116 of the switching transistor QS and the second gate electrode 120 of the driving transistor QD are electrically connected to each other through a first bridge pattern 132 connecting a first contact hole CNT1 and a second contact hole CNT2. The unit pixel section ELP includes a pixel electrode layer 134 that is electrically connected to the second drain electrode 126 of the driving transistor QD through a third contact hole CNT3. The pixel electrode layer 134 includes an optically transparent and electrically conductive material such as indium tin oxide (ITO) or indium zinc oxide (IZO). The first bridge pattern 132 is formed from a layer identical to the pixel electrode layer 134. The pixel electrode layer 134 defines a storage capacitor CST by overlapping the second gate electrode 120.

The unit pixel section ELP further includes a wall (not shown), an electro-luminescent layer (not shown), an opposite electrode layer (not shown) facing to the pixel electrode layer 134 and a protecting layer (not shown). The wall is formed on the pixel electrode layer 134 to define a light-emitting area. The electro-luminescent layer is formed on a portion having no wall formed thereon. The opposite electrode layer is formed on the electro-luminescent layer and the wall. The protecting layer is formed on the opposite electrode layer. In FIG. 3, a dotted line defines a portion having the wall formed thereon. In detail, the wall is formed in an outer area that is defined by the dotted line.

When the electro-luminescent layer is formed by laminating, a relatively higher light-emitting efficiency of the electro-luminescent layer is obtained. For example, the electro-luminescent layer may include a hole injecting layer, a hole transporting layer, a light-emitting layer and an electron transporting layer that are sequentially formed on the pixel electrode layer 134. For another example, the electro-luminescent layer may include a hole transporting layer, a light-emitting layer and an electron transporting layer that are sequentially formed on the pixel electrode layer 134. In still another example, the electro-luminescent layer may include a hole injecting layer, a hole transporting layer, a light-emitting layer, an electron transporting layer and a hole injecting layer sequentially formed on the pixel electrode layer 134.

When the OLED according to the present invention corresponds to an independent light-emitting type and a bottom light-emitting type, the electro-luminescent layer corresponds to an organic light-emitting layer that emits a red light (R), a green light (G) or a blue light (B) and the opposite electrode layer includes metal. The bottom light-emitting type OLED outputs a light for displaying an image, which is generated at a bottom portion of the OLED and is provided downwards. When the pixel electrode layer 134 performs an anode (or a positive polarity) function, the opposite electrode layer facing to the pixel electrode layer 134 performs a cathode (or a negative polarity) function. When the pixel electrode layer 134 performs a cathode (or a negative polarity) function, the opposite electrode layer performs an anode (or a positive polarity) function.

When the OLED according to the present invention corresponds to an independent light-emitting type and a top light-emitting type, the electro-luminescent layer corresponds to an organic light-emitting layer that emits a red light (R), a green light (G) or a blue light (B), and the opposite electrode layer includes an optically transparent and electrically conductive material such as indium tin oxide (ITO) or indium zinc oxide (IZO). The top light-emitting type OLED outputs a light for displaying an image, which is generated at a top portion of the OLED and is provided upwards.

The power supply lines VDL are formed substantially parallel to the data lines DL. For example, two or more adjacent power supply lines VDL are electrically connected to each other in a fan-out portion of the data line. Each even-numbered data line among the data lines DL is divided at an overlapped portion where the even-numbered data lines overlap with the power supply line VDL.

According to the present embodiment, the connecting section CND includes a second bridge pattern 136 that is formed from the same layer as that of the pixel electrode layer 134. The connecting section CND electrically connects a divided even-numbered data line. In detail, the second bridge pattern 136 is electrically connected to a first terminal of a divided even-numbered data line that is formed in a relatively lower layer through a fourth contact hole CNT4, and the second bridge pattern 136 is electrically connected to a second terminal of the divided even-numbered data line that is formed in a relatively lower layer through a fifth contact hole CNT5.

### Embodiment 2

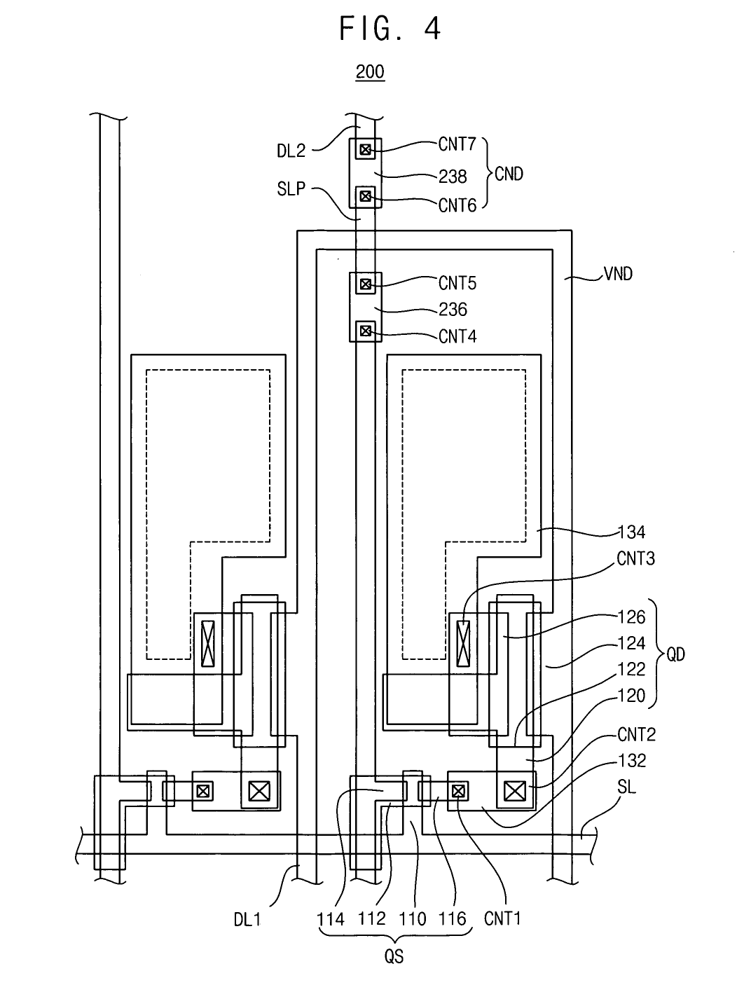

FIG. 4 is a plan view illustrating a portion of an OLED display panel according to another example embodiment of the present invention. FIG. 4 shows a method of directly connecting a power supply line when forming source and drain electrodes, and connecting a data line with a bridge pattern. Referring to FIGS. 2 and 4, a unit pixel section ELP of the OLED display panel 200 according to another example embodiment of the present invention is formed in a region defined by a scan line SL supplying a scan signal, a data line DL supplying a data signal and a power supply line VDL supplying a bias power voltage VDD. In FIG. 4, the same reference numerals represent the same elements in FIG. 3, and thus detailed descriptions of the same elements will be omitted. The power supply lines VDL are formed substantially parallel with the data lines DL. Two or more adjacent power supply lines VDL are electrically connected to each other in a fan-out region of the data line. Each even-numbered data line among the data lines DL is divided at an overlapped portion where the even-numbered data lines overlap with the power supply line VDL.

The connecting section CND includes a scan line pattern SLP that is formed from the same layer as the scan line, and second and third bridge patterns 236 and 238 that are formed from the same layer as the pixel electrode layer 134. The connecting section CND is formed so that an electrical connection between two portions of a divided even-numbered data line is possible. The scan line pattern SLP is formed to cover a crossing area where the scan line pattern SLP overlaps with the power supply line VDL. The second bridge pattern 236 is electrically connected to a first terminal of a divided even-numbered data line that is formed in a relatively lower layer through a fourth contact hole CNT4. The second bridge pattern 236 is electrically connected to a first terminal of the scan line pattern SLP that is formed in a relatively lower layer through a fifth contact hole CNT5. The third bridge pattern 238 is electrically connected to a second terminal of the divided even-numbered data line that is formed in a relatively lower layer through a sixth contact hole CNT6. The third bridge pattern 238 is electrically connected to a second terminal of the scan line pattern SLP that is formed in a relatively lower layer through a seventh contact hole CNT7.

### Embodiment 3

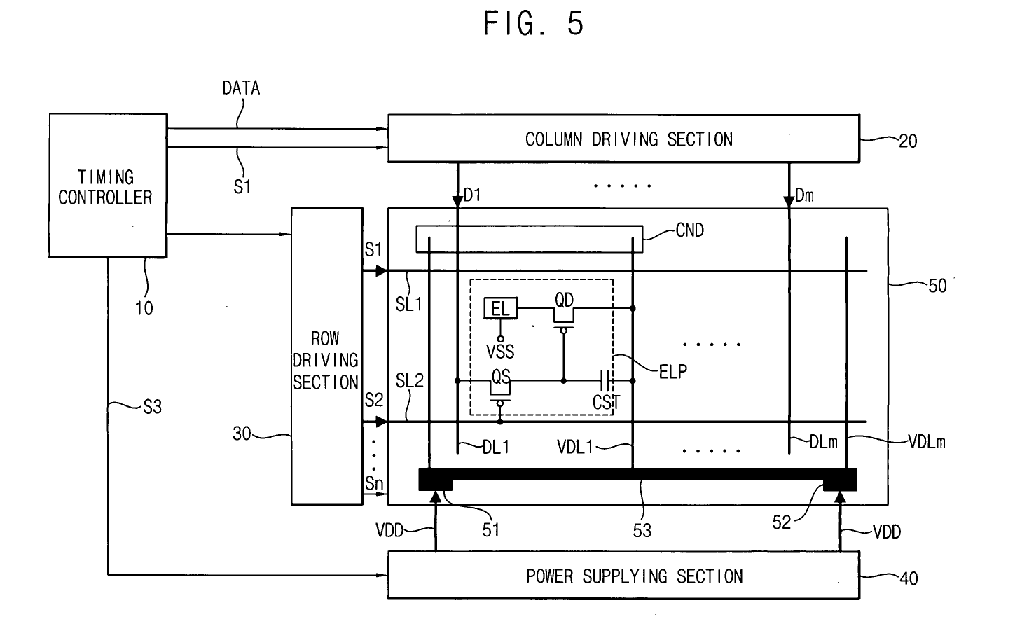

FIG. 5 is a block diagram illustrating an OLED according to still another example embodiment of the present invention. Especially, FIG. 5 shows power supply lines electrically connected to each other through a bridge pattern. Referring to FIG. 5, an OLED according to still another example embodiment of the present invention includes a timing controller 10, a column driving section 20, a row driving section 30, a power supplying section 40 and an OLED display panel 50. In FIG. 5, the same reference numerals represent the same elements in FIG. 2, and thus detailed descriptions of the same elements will be omitted. The OLED display panel 50 includes a plurality of OLED pixel sections ELP. The OLED pixel sections ELP are formed on an effective display region defined by m number of data lines DL, m number of power supply lines VDL and n number of scan lines SL. The m number of data lines DL transfer data signals D1, D2, Dm−1 and Dm to the effective display region. The m number of power supply lines VDL transfer a bias power voltage VDD to the effective display region. The n number of scan lines SL transfer scan signals S1, S2, . . . , Sn−1 and Sn to the effective display region. The OLED display panel 50 emits light by controlling a current corresponding to the bias power voltage VDD and the data signals D1, D2, . . . , Dm−1 and Dm in response to the scan signals S1, S2, . . . , Sn−1 and Sn.

The power supply lines VDL are formed substantially parallel with the data line DL. For example, two or more adjacent power supply lines VDL are electrically connected to each other through the connecting section CND. The power supply lines VDL transfer a bias power voltage VDD that is applied from the bridge line 53 to the OLED pixel section ELP. The power supply lines VDL are formed during a patterning process of forming a lower or upper electrode of the OLED element EL. The patterning process includes a photolithography process. The electro-luminescent element EL is disposed at the OLED pixel section ELP.

A bias power voltage VDD provided from the power supplying section 40 is applied to the first and second stations 51 and 52. Then, the bias power voltage VDD provided to the first and second stations 51 and 52 is applied to the power supply lines VDL that are formed on the effective display region of the OLED display panel 50 through the bridge line VDL.

According to the above-mentioned structure, two or more adjacent power supply lines VDL are electrically connected to each other. Even though a short defect occurs in a power supply line, a bias power voltage may be applied to a unit pixel section ELP through another power supply line adjacent to the open power supply line, so that damage due to the short defect is minimized. That is, a line-unit-error that occurs in a power supply line is converted to a pixel-unit-error. Also, since two or more adjacent power supply lines are electrically connected to each other in an inactive display region even though an electrical short may occur between the power supply line and the data line, two portions of the power supply line having the electrical short may be opened. Therefore, a repairing process may be easily performed. Furthermore, a crossing area between the power supply line and the data line may be decreased in a fan-out region. For example, the crossing area may be reduced from an order of ‘mm²’ to an order of ‘μm²’. Therefore, damage due to an electrical short that may occur between a fan-out layer of the power supply line that is formed from the same layer as the gate electrode layer, and a power supply line that is formed from the same layer as the source-drain electrode layer, is minimized.

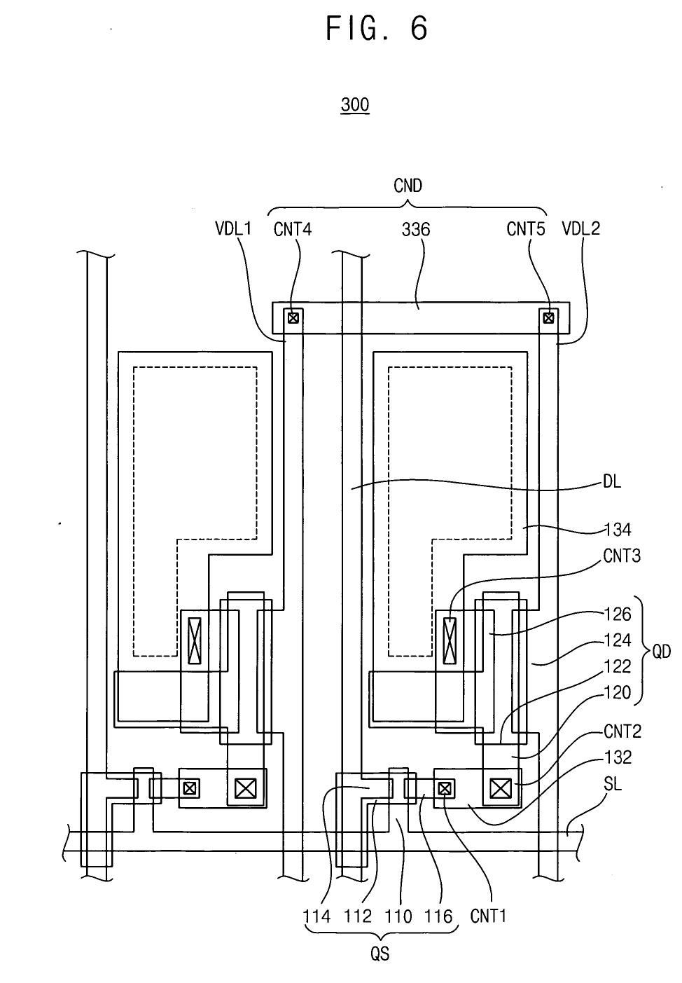

FIG. 6 is a plan view illustrating a portion of an OLED display panel according to still another example embodiment of the present invention. Particularly, FIG. 6 shows a unit pixel section and a connecting section of the OLED display panel in FIG. 5. Referring to FIGS. 5 and 6, a unit pixel section that is disposed in an OLED display panel 100 according to still another example embodiment of the present invention is formed in a portion defined by a scan line SL supplying a scan signal, a data line DL supplying a data signal and a power supply line VDL supplying a bias power voltage VDD. In FIG. 6, the same reference numerals represent the same elements in FIG. 3, and thus detailed descriptions of the same elements will be omitted.

The power supply lines VDL are formed substantially parallel with the data lines DL. The connecting section CND includes a second bridge pattern 336 that is formed from the same layer as the pixel electrode layer 134. The connecting section CND electrically connects to two or more adjacent power supply lines in a fan-out portion. The second bridge pattern 336 is formed to cross with an even-numbered data line. The second bridge pattern 336 is electrically connected to a first power supply line VDL1 corresponding to an odd-numbered pixel section extended in a row direction through the fourth contact hole CNT4. The second bridge pattern 336 is electrically connected to a second power supply line VDL2 corresponding to an even-numbered pixel section extended in a row direction through the fifth contact hole CNT5.

### Embodiment 4

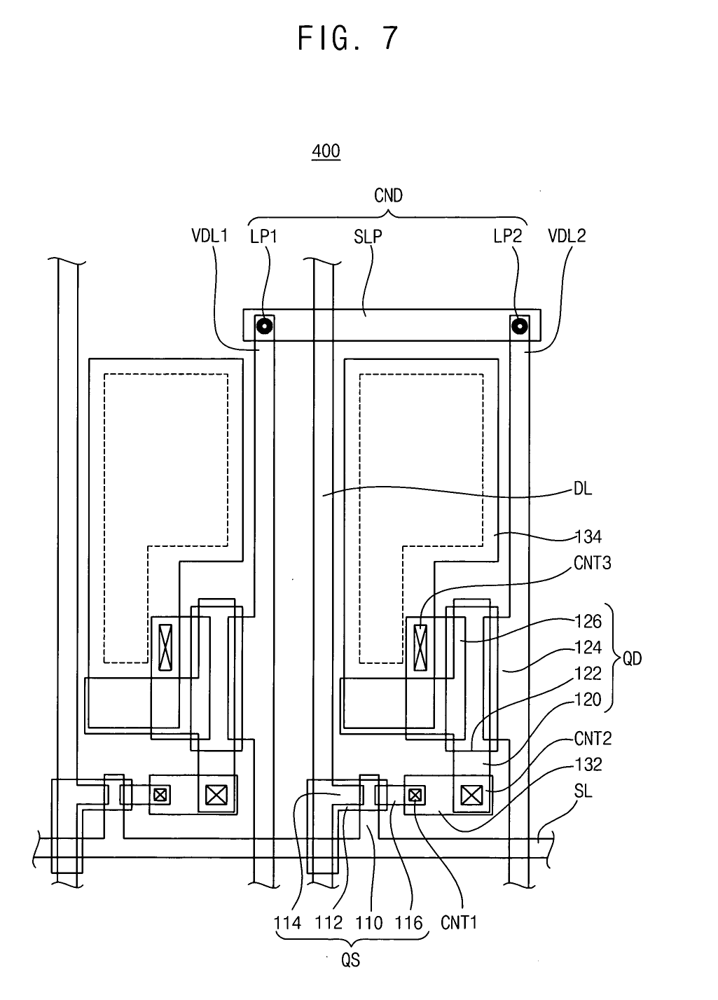

FIG. 7 is a plan view illustrating a portion of an OLED display panel according to still another example embodiment of the present invention. Especially, FIG. 7 shows a unit pixel section and a connecting section. FIG. 7 also shows a method of connecting a repair bar that is formed through a process of forming a scan line and a power supply line. Referring to FIGS. 5 and 7, a unit pixel section that is disposed in an OLED display panel 400 is formed in a portion defined by a scan line SL supplying a scan signal, a data line DL supplying a data signal and a power supply line VDL supplying a bias power voltage VDD. In FIG. 7, the same reference numerals represent the same elements in FIG. 3, and thus detailed descriptions of the same elements will be omitted.

The power supply lines VDL are formed substantially parallel with the data lines DL. The connecting section CND includes a scan line pattern SLP that is formed from the same layer as the scan line SL. The connecting section CND electrically connects to two or more adjacent power supply lines in a fan-out portion. The second line pattern SLP is formed to cross with an even-numbered data line. The scan line pattern SLP is electrically connected to a first power supply line VDL1 corresponding to an odd-numbered pixel section in a row direction through a first laser point LP1. The second line pattern SLP is electrically connected to a second power supply line VDL2 corresponding to an even-numbered pixel section in a row direction through a second laser point LP2.

### Embodiment 5

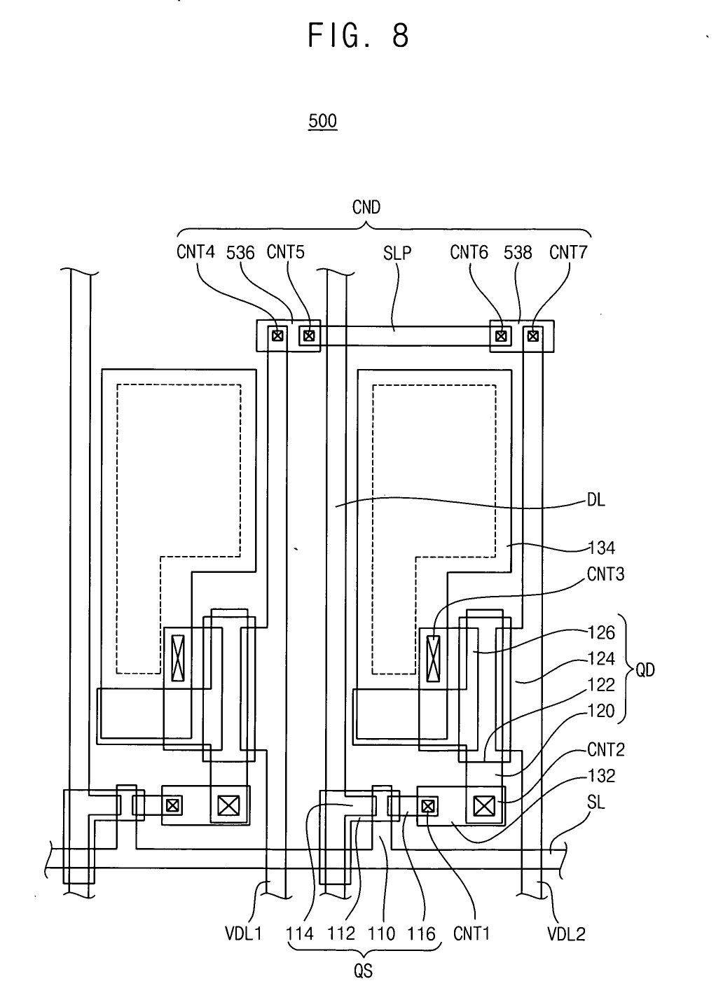

FIG. 8 is a plan view illustrating a portion of an OLED display panel according to further still another example embodiment of the present invention. Especially, FIG. 8 shows a unit pixel section and a connecting section. FIG. 8 also shows a method of connecting a repair bar that is formed through a process of forming a scan line and a power supply line. Referring to FIGS. 5 and 8, a unit pixel section that is disposed in an OLED display panel 500 according to still another example embodiment of the present invention is formed in a portion defined by a scan line SL supplying a scan signal, a data line DL supplying a data signal and a power supply line VDL supplying a bias power voltage VDD. In FIG. 8, the same reference numerals represent the same elements in FIG. 3, and thus detailed descriptions of the same elements will be omitted.

The power supply lines VDL are formed substantially parallel with the data lines DL. The second bridge pattern 536 is electrically connected to a first terminal of a power supply line VDL1 corresponding to an odd-numbered pixel section in a row direction, which is formed in a relatively lower layer through a fourth contact hole CNT4. The second bridge pattern 536 is electrically connected to a first terminal of the scan line pattern SLP that is formed in a relatively lower layer through a fifth contact hole CNT5. he third bridge pattern 538 is electrically connected to a second terminal of the scan line pattern SLP that is formed in a relatively lower layer through a sixth contact hole CNT6. The third bridge pattern 538 is electrically connected to a second terminal of the power supply line VDL2 corresponding to an even-numbered pixel section in a row direction, which is formed in a relatively lower layer through a seventh contact hole CNT7.

### Embodiment 6

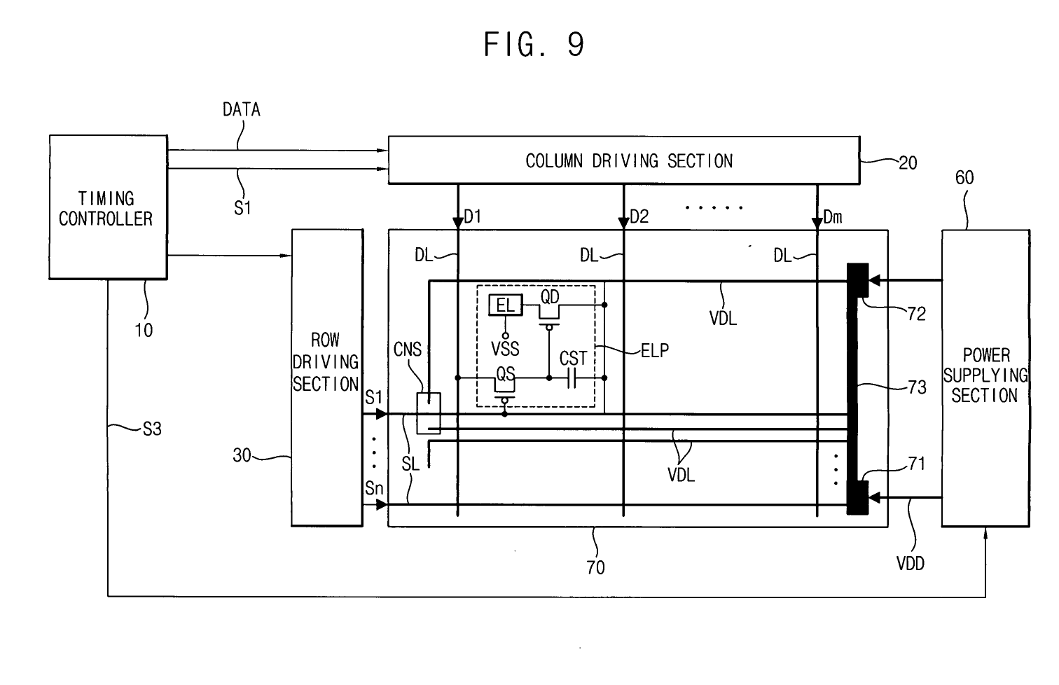

FIG. 9 is a block diagram illustrating an OLED according to further still another example embodiment of the present invention. Especially, FIG. 9 shows a method of connecting adjacent power supply lines using only a bridge pattern. Referring to FIG. 9, the OLED according to further still another example embodiment of the present invention includes a timing controller 10, a column driving section 20, a row driving section 30, a power supplying section 60 and an OLED display panel 70. The timing controller 10, the column driving section 20, the row driving section 30 and the power supplying section 60 comprise a driving device of the OLED display device. In FIG. 9, the same reference numerals denote the same elements as in FIG. 2, and thus detailed descriptions of the same elements will be omitted.

The power supplying section 60 receiving the power control signal S3 provides a plurality of power supply lines VDL of the OLED display panel 70 with a bias power voltage VDD. The OLED display panel 70 includes a first station 71, a second station 72 and a bridge line 73 that connects to the first station 71 and the second station 72. The first and second stations 71 and 72 and the bridge line 73 are formed in a first inactive display region of the OLED display panel 70. The OLED display panel 70 includes a plurality of OLED pixel sections ELP. The OLED pixel sections ELP are formed on an effective display region defined by m number of data lines DL, m number of power supply lines VDL and n number of scan lines SL. The m number of data lines DL transfer data signals D1, D2, . . . , Dm−1 and Dm to the effective display region. The m number of power supply lines VDL transfer a bias power voltage VDD to the effective display region. The n number of scan lines SL transfer scan signals S1, S2, . . . , Sn−1 and Sn to the effective display region. The OLED display panel 70 emits light by controlling a current corresponding to the bias power voltage VDD and the data signals D1, D2, . . . , Dm−1 and Dm in response to the scan signals S1, S2, . . . , Sn−1 and Sn. The OLED pixel section ELP includes a switching transistor QS, a driving transistor QD, an electro-luminescent element EL and a storage capacitor CST. The OLED pixel section ELP displays images in accordance with an image signal outputted from the column driving section 20 in response to a scan signal outputted from the row driving section 30. A detailed description of the OLED pixel section ELP is omitted since the OLED pixel section ELP is explained in FIG. 2.

The power supply lines VDL are formed substantially parallel with the scan line SL. For example, two or more adjacent power supply lines VDL are electrically connected to each other. The power supply lines VDL transfer a bias power voltage VDD that is applied from the bridge line 73 to the OLED pixel section ELP. The OLED display panel 70 includes a connecting section CNS that is formed on a crossing area with the power supply line VDL. The connecting section CNS electrically connects to a portion of an open power supply line VDL and another portion thereof. The connecting section CNS is formed in a second inactive display region of the OLED display panel 70. A bias power voltage VDD provided from the power supplying section 60 is applied to the first and second stations 71 and 72, respectively. Then, the bias power voltage VDD provided to the first and second stations 71 and 72 is applied to the power supply lines VDL that are formed on the effective display region of the OLED display panel 70 through the bridge line 73. In FIG. 9, the OLED display panel 70 includes two stations. However the OLED display panel 70 may include three or more stations in order to uniformly apply the bias power voltage that is applied from an external device to the OLED display panel 70.

According to the above-mentioned structure, two or more adjacent power supply lines VDL are electrically connected to each other. Therefore, even though short defects occur in some of the power supply lines VDL, a bias power voltage may be applied to a unit pixel section ELP through another power supply line adjacent to the open power supply line VDL, so that damage due to the short defects is minimized. In other words, a line-unit-error that occurs in some of the power supply lines VDL is converted to a pixel-unit-error, so that damage due to the short defects corresponding to the line-opening is minimized. Since two or more adjacent power supply lines are electrically connected to each other in an inactive display region even though an electrical short may occur between the power supply line and the data line, two portions of the power supply line having the electrical short may be opened. Therefore, a repairing process may be easily performed.

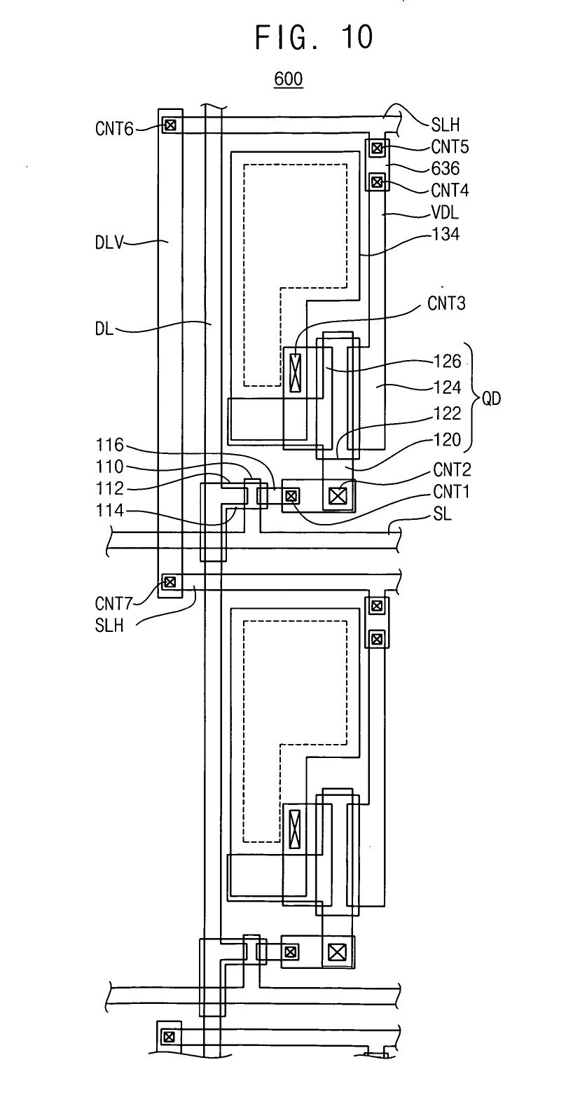

FIG. 10 is a plan view illustrating a unit pixel section and a connecting section in FIG. 9. Referring to FIG. 10, a unit pixel section of the OLED display panel 600 according to further still another example embodiment of the present invention is formed a region defined by a scan line SL supplying a scan signal, a data line DL supplying a data signal and a first power supply line VDL supplying a bias power voltage VDD. In FIG. 10, the same reference numerals represent the same elements in FIG. 3, and thus detailed descriptions of the same elements will be omitted. The first power supply lines VDL are formed substantially parallel with the data lines DL. A second power supply line SLH and a data line pattern DLV are formed on the OLED display panel 600. The second power supply line SLH is formed parallel with the scan line SL. The second power supply line SLH transfers the bias power voltage VDD to the first power supply line VDL. The data line pattern DLV is formed in an outset area. The data line pattern DLV electrically connects to each second power supply line SLH corresponding to two pixel sections adjacent to each other in a column direction.

The second power supply line SLH is electrically connected to the first power supply line VDL through a bridge pattern 636 that is formed from the same layer as the pixel electrode layer 134. The bridge pattern 636 is electrically connected to the first and second power supply lines VDL and SLH through the fourth and fifth contact holes CNT4 and CNT5, respectively. The data line pattern DLV is formed from the same layer as the data line DL. The data line pattern DLV is electrically connected to a terminal portion of the second power supply line SLH corresponding to an odd-numbered pixel section in a column direction through the sixth contact hole CNT6. The data line pattern DLV is electrically connected to a terminal portion of the second power supply line SLH corresponding to an even-numbered pixel section in a column direction through the seventh contact hole CNT6.

### Embodiment 7

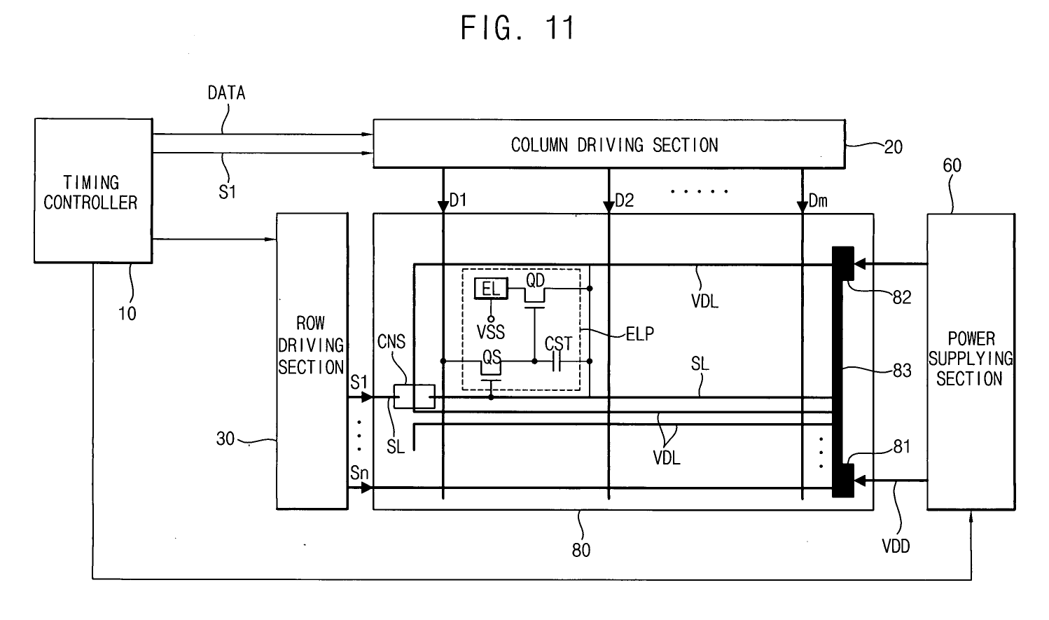

FIG. 11 is a block diagram illustrating an OLED according to further still another example embodiment of the present invention. Especially, FIG. 11 shows a connection between the power supplying lines through a bridge pattern. Referring to FIG. 11, an OLED according to further still another example embodiment of the present invention includes a timing controller 10, a column driving section 20, a row driving section 30, a power supplying section 60 and an OLED display panel 80. The timing controller 10, the column driving section 20, the row driving section 30 and the power supplying section 60 are a driving device of the OLED display panel 80. In FIG. 11, the same reference numerals represent the same elements in FIG. 2, and thus detailed descriptions of the same elements will be omitted. The OLED display panel 80 includes a first station 81, a second station 82, a bridge line 83 for electrically connecting the first station 81 and the second station 82. The first and second stations 81 and 82 and bridge line 83 are formed in a first inactive display region of the OLED display panel 80. The OLED display panel 80 includes a plurality of OLED pixel sections ELP. The OLED pixel sections ELP are formed on an effective display region defined by m number of data lines DL, m number of power supply lines VDL and n number of scan lines SL. The m number of data lines DL transfer data signals D1, D2, . . . , Dm−1 and Dm to the effective display region. The m number of power supply lines VDL transfer a bias power voltage VDD to the effective display region. The n number of scan lines SL transfer scan signals S1, S2, . . . , Sn−1 and Sn to the effective display region. The OLED display panel 80 emits light by controlling a current corresponding to the bias power voltage VDD and the data signals D1, D2, . . . , Dm−1 and Dm in response to the scan signals S1, S2, . . . , Sn−1 and Sn.

The OLED pixel section ELP includes a switching transistor QS, a driving transistor QD, an electro-luminescent element EL and a storage capacitor CST. The OLED pixel section ELP displays images in accordance with an image signal outputted from the column driving section 20 in response to a scan signal outputted from the row driving section 30. The OLED pixel section ELP is described in FIG. 6, and thus detailed descriptions of the identical element will be omitted.

The power supply lines VDL are formed substantially parallel with the scan line SL. Two or more adjacent power supply lines VDL are electrically connected to each other. The power supply lines VDL transfer a bias power voltage VDD that is applied from the bridge line 83 to the OLED pixel section ELP. The OLED display panel 80 includes a connecting section CNS that is formed on a crossing area with the power supply line VDL. The connecting section CNS electrically connects to one portion of an open power supply line VDL and another portion thereof. The connection section CNS is formed in a second inactive display region of OLED display panel 80. In FIG. 11, the OLED display panel 80 includes two stations. However the OLED display panel 80 may include three or more stations in order to uniformly apply the bias power voltage that is applied from an external device to the OLED display panel 80.

According to the above-mentioned structure, two or more adjacent power supply lines VDL are electrically connected to each other. Therefore, even though short defects occur in some of the power supply lines VDL, a bias power voltage may be applied to a unit pixel section ELP through another power supply line adjacent to the open power supply line VDL, so that damage due to the short defects is minimized. In other words, a line-unit-error that occurs in some of the power supply lines VDL is converted to a pixel-unit-error, so that damage due to the short defects corresponding to the line-opening is minimized. Also, two or more adjacent power supply lines are electrically connected to each other in an inactive display region. Therefore, even though an electrical short may occur between the power supply line and the data line, two portions of the power supply line having the electrical short may be opened. Therefore, a repairing process may be easily performed.

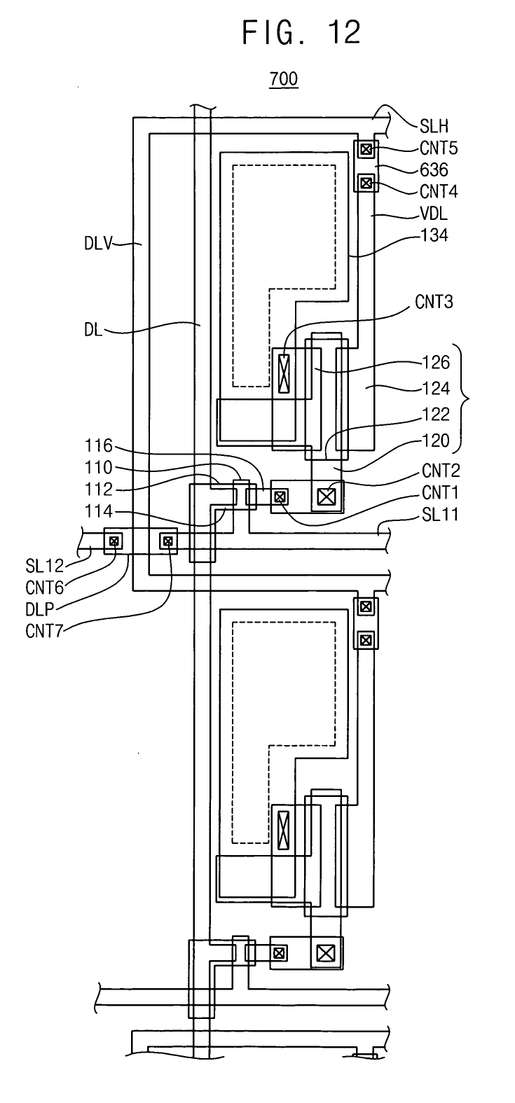

FIG. 12 is a plan view illustrating a unit pixel section and a connecting section in FIG. 11.

Referring to FIG. 12, a unit pixel section that is disposed in an OLED display panel 700 according to further still another example embodiment of the present invention is formed in a portion defined by a scan line SL supplying a scan signal, a data line DL supplying a data signal and a first power supply line VDL supplying a bias power voltage VDD. In FIG. 12, the same reference numerals represent the same elements in FIG. 3, and thus detailed descriptions of the same elements will be omitted. The first power supply lines VDL are formed substantially parallel with the data lines DL. A second power supply line SLH is formed on the OLED display panel 700, parallel with the scan line SL. The second power supply line SLH transfers the bias power voltage VDD to the first power supply line VDL. The second power supply line SLH electrically connects to the second power supply line SLH corresponding to a pixel section that is adjacent in a column direction. An odd-numbered scan line SL is divided into a main scan line SL11 and a terminal portion scan line SL12. The main scan line SL11 is electrically connected to unit pixel sections arranged in a row direction. The terminal portion scan line SL12 is formed at an outer area of the OLED display panel 700. The terminal portion scan line SL12 is electrically connected to the main scan line SL11 through the bridge pattern DLP that is formed as a layer identical to the pixel electrode layer 134. The bridge pattern DLP is electrically connected to the terminal portion scan line SL12 and the main scan line SL11 through sixth and seventh contact holes CNT6 and CNT7, respectively.

As described above, two or more adjacent power supply lines are electrically connected to each other in an inactive display region. Therefore, an error of a power supply line is minimized. The error of a power supply line is induced by shorting between the power supply line and the data line, or by shorting between the power supply line and the scan line. Furthermore, the crossing area between the power supply line and the data line or the crossing area between the power supply line and the scan line is minimized so that the possibility of an opening induced by the crossing area is minimized. Since two or more adjacent power supply lines are electrically connected to each other in an inactive display region even though an electrical short may occur between the power supply line and the data line, two portions of the power supply line corresponding to the shorted defects are opened. Therefore, a repair process may be easily performed. Furthermore, a crossing area between the power supply line and the data line is decreased in a fan-out region. Therefore, an upper/lower shorted error is minimized. The upper/lower shorted error occurs between a fan-out layer of the power supply line that is formed from the same layer as the gate electrode layer and a power supply line that is formed from the same layer as the source-drain electrode layer.

Although the example embodiments of the present invention have been described, it is understood that the present invention should not be limited to these example embodiments but various changes and modifications can be made by one ordinary skilled in the art within the spirit and scope of the present invention as hereinafter claimed.

What is claimed is:

1. An organic light-emitting device comprising:
a scan line supplying a scan signal;
a data line supplying a data signal;
a power supply line supplying a bias power voltage;
an organic light-emitting element that is electrically connected to the scan line, the data line and the power supply line; and
a connecting section that electrically connects m number of the power supply lines that are adjacent to each other, wherein m represents a natural number greater than one.

2. The organic light-emitting device of claim 1, wherein the data line and the power supply line are extended toward opposite directions to each other, and the connecting section is formed in at least one region including a starting region of the data line.

3. The organic light-emitting device of claim 1, wherein the number m is two.

4. The organic light-emitting device of claim 1, wherein the scan line and the power supply line are extended toward opposite directions to each other, and the connecting section is formed in at least one region including a starting region of the scan line.

5. The organic light-emitting device of claim 1, wherein the connecting section comprises a scan line pattern that is formed from the same layer as the scan line,
a first end portion of the scan line pattern is overlapped with a portion of the first power supply line that is extended along a vertical direction, a second end portion of the scan line pattern is overlapped with a portion of the second power supply that is adjacent to the first power supply line, when viewed on a plane, and
the scan line pattern electrically connects the first power supply line and the second power apply line to each other through a laser point.

6. The organic light-emitting device of claim 1, wherein the connecting section comprises:
a scan line pattern that is formed from the same layer as the scan line;
a first bridge pattern that electrically connects a first portion of the scan line pattern and a first portion of the first power supply line that is extended along a vertical direction through a first contact hole; and
a second bridge pattern that electrically connects a second portion of the scan line pattern and a first portion of a second power supply line that is adjacent to the first power supply line and that is extended along the vertical direction through a second contact hole.

7. The organic light-emitting device of claim 1, wherein the connecting section comprises a bridge pattern that is formed from the same layer as the transparent electrode of the organic light-emitting element, a first portion of the bridge pattern is electrically connected to a portion of a first power supply line that is extended along a vertical direction through a third contact hole, and a second portion of the bridge pattern is electrically connected to a portion of a second current supply that is adjacent to the first power supply line.

8. The organic light-emitting device of claim 1, wherein the connecting section comprises a data line pattern that is formed from the same layer as the data line, a first portion of the data line pattern is overlapped with a portion of the first power supply line that is extended along a horizontal direction, a second portion of the data line pattern is overlapped with a portion of the second current supply that is adjacent to the first power supply line, when viewed on a plane, and
the data line pattern electrically connects the first power supply line and the second power apply line to each other through a laser point.

9. The organic light-emitting device of claim 1, wherein the connecting section comprises:
a data line pattern that is formed from the same layer as the data line;
a first bridge pattern that electrically connects a first portion of the data line pattern and a first portion of a first power supply line that is extended along a horizontal direction through a fifth contact hole; and
a second bridge pattern that electrically connects a second portion of the data line pattern and a first portion of a second power supply line that is adjacent to the first power supply line and that is extended along the horizontal direction through a sixth contact hole.

10. The organic light-emitting device of claim 1, wherein the connecting section comprises a bridge pattern that is formed from the same layer as the transparent electrode of the organic light-emitting element, a first portion of the bridge pattern is electrically connected to a portion of a first power supply line that is extended along a horizontal direction through a seventh contact hole, and a second portion of the bridge pattern is electrically connected to a portion of a second power supply line that is adjacent to the first power supply line through a eighth contact hole.

11. An organic light-emitting device comprising:
a plurality of first lines that are extended along a first direction;
a plurality of power supply lines supplying a bias power voltage, m number of power supply lines being electrically connected to each other in a first region;
a plurality of second lines that is extended along a second direction, each of the second lines being divided to form a first portion, a second portion and an opening portion crossing the power supply line that is formed in the first region, the opening portion being disposed between the first and second portions;
an organic light-emitting element electrically connected to the first and second lines and the power supply line; and
a connecting section electrically connecting the first and second portions of the second line, wherein m represents a natural number greater than one.

12. The organic light-emitting device of claim 11, wherein the first line is a scan line supplying a scan signal, and the second line is a data line supplying a data signal.

13. The organic light-emitting device of claim 12, wherein the connecting section comprises:
a scan line pattern that is formed from the same layer as the scan line corresponding to the first region;
a first bridge pattern that electrically connects the scan line pattern and a first portion of the open data line through a first contact hole; and
a second bridge pattern that electrically connects the scan line pattern and a remaining portion of the open data line through a second contact hole.

14. The organic light-emitting device of claim 12, wherein the connecting section comprises a bridge pattern that is formed from the same layer as the transparent electrode of the organic light-emitting element, and
the bridge pattern is electrically connected to a portion of the open data line through a third contact hole, and is electrically connected to a remaining portion thereof through a fourth contact hole.

15. The organic light-emitting device of claim 11, wherein the first line is a data line supplying a data signal, and the second line is a scan line supplying a scan signal.

16. The organic light-emitting device of claim 15, wherein the connecting section comprises a bridge pattern that is formed from the same layer as the transparent electrode of the organic light-emitting element, and
the bridge pattern is electrically connected to a portion of the open scan line through a fifth contact hole, and is electrically connected to a remaining portion thereof through a sixth contact hole.

17. An organic light-emitting device comprising:
a column driving section receiving an image signal and a first timing signal and outputting a data signal;
a row driving section receiving a second timing signal and outputting a scan signal;
a power supplying section receiving a power control signal and outputting a power voltage; and
an organic light-emitting panel emitting light by controlling a current corresponding to the data signal in accordance with the power voltage and the scan signal, the OLED display panel having a scan line supplying the scan signal, a data line supplying the data signal, a power supply line supplying the power voltage, an organic light-emitting element that is electrically connected to the scan line, the data line and the power supply line, and a connecting section electrically connecting m number of the power supply lines that are adjacent to each other, wherein m represents a natural number greater than one.

18. An organic light-emitting device comprising:
a column driving section receiving an image signal and a first timing signal, and outputting a data signal;
a row driving section receiving a second timing signal, and outputting a scan signal;
a power supplying section receiving a power control signal, and outputting a power voltage; and
an OLED display panel emitting light by controlling a current corresponding to the data signal in accordance with the power voltage and the scan signal, the OLED display panel having a plurality of first lines extended along a first direction, a plurality of power supply lines supplying a plurality of power voltages, m number of power supply lines being electrically connected to each other in a first region, a plurality of second lines extended along a second direction, each of the second lines being divided to have a first portion, a second portion and an opening portion being disposed between the first and second portions and crossing the power supply line formed in the first region, an organic light-emitting element that is electrically connected to one of the first lines, one of the second lines and one of the power supply lines, and a connecting section that electrically connects the first and second portions of the second line in the first region, wherein m represents a natural number greater than one.

19. The organic light-emitting device of claim 18, wherein the first line is a scan line supplying a scan signal, and the second line is a data line supplying a data signal.

20. The organic light-emitting device of claim 19, wherein the connecting section comprises:
a scan line pattern that is formed from the same layer as the scan line corresponding to the first region;
a first bridge pattern that electrically connects the scan line pattern and first portion of the open data line through a first contact hole; and
a second bridge pattern that electrically connects the scan line pattern and a remaining portion of the open data line through a second contact hole.

21. The organic light-emitting device of claim 19, wherein the connecting section comprises a bridge pattern that is formed from the same layer as the transparent electrode of the organic light-emitting element,
the bridge pattern being electrically connected to the first portion of the divided data line through a third contact hole, and being electrically connected to the second portion of the divided data line through a fourth contact hole.

22. The organic light-emitting device of claim 18, wherein the first line is a data line supplying a data signal, and the second line is a scan line supplying a scan signal.

23. The organic light-emitting device of claim 22, wherein the connecting section comprises a bridge pattern that is formed from a layer as the transparent electrode of the organic light-emitting element,
the bridge pattern that is electrically connected to the first portion of the divided scan line through a fifth contact hole, and is electrically connected to the second portion of the divided scan line through a sixth contact hole.
